(19) United States
(12) Patent Application Publication
(10) Pub. No.: US 2023/0281509 A1
(43) Pub. Date: Sep. 7, 2023

(54) TEST-TIME ADAPTATION WITH UNLABELED ONLINE DATA

(71) Applicant: QUALCOMM Incorporated, San Diego, CA (US)

(72) Inventors: Sungha CHOI, Goyang-si (KR); Seunghan YANG, Incheon (KR); Seokeon CHOI, Yongin-si (KR); Sungrack YUN, Seongnam (KR)

(21) Appl. No.: 18/086,586

(22) Filed: Dec. 21, 2022

Related U.S. Application Data
(60) Provisional application No. 63/316,916, filed on Mar. 4, 2022.

(51) Int. Cl. G06N 20/00

(52) U.S. Cl. CPC G06N 20/00

(57) ABSTRACT

A processor-implemented method includes training a machine learning model on a source domain. The method also includes testing the machine learning model on a target domain, after training. The method further includes training the machine learning model on the target domain by regularizing weights of the machine learning model such that shift-agnostic weights are subjected to a higher penalty than shift-biased weights.

### CROSS-REFERENCE TO RELATED APPLICATION

The present application claims the benefit of U.S. Provisional Pat. Application No. 63/316,916, filed on Mar. 4, 2022, and titled “TEST-TIME ADAPTATION WITH UNLABELED ONLINE DATA,” the disclosure of which is expressly incorporated by reference in its entirety.

### FIELD OF THE DISCLOSURE

Aspects of the present disclosure generally relate to test-time adaptation with unlabeled online data.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Deep neural network (DNN) models may be trained using a given dataset (e.g., source domain). After initial training in the source domain, the model may be deployed and tested on a new environment (e.g., target domain). However, in most cases, there is a distribution gap between the source domain and the target domain. That is, the source and target domains are often different from one another. Thus, the model performance in the target domain is not as good as in the source domain. Moreover, if the distribution gap is quite large, severe performance degradation may be observed.

### SUMMARY

In aspects of the present disclosure, a processor-implemented method includes training a machine learning model on a source domain. The method also includes testing the machine learning model on a target domain, after training the machine learning model on the source domain. The method further includes training the machine leaming model on the target domain by regularizing weights of the machine learning model such that shift-agnostic weights are subjected to a higher penalty than shift-biased weights.

Other aspects of the present disclosure are directed to an apparatus. The apparatus has a memory and one or more processor(s) coupled to the memory, the processor(s) is configured to train a machine learning model on a source domain. The processor(s) is also configured to test the machine learning model on a target domain, after training the machine learning model on the source domain. The processor(s) is further configured to train the machine learning model on the target domain by regularizing weights of the machine learning model such that shift-agnostic weights are subjected to a higher penalty than shift-biased weights.

Other aspects of the present disclosure are directed to an apparatus. The apparatus includes means for training a machine learning model on a source domain. The apparatus also includes means for testing the machine learning model on a target domain, after training the machine learning model on the source domain. The apparatus further includes means for training the machine learning model on the target domain by regularizing weights of the machine learning model such that shift-agnostic weights are subjected to a higher penalty than shift-biased weights.

In still other aspects of the present disclosure, a non-transitory computer-readable medium having program code recorded thereon is disclosed. The program code is executed by a processor and includes program code to train a machine learning model on a source domain. The program code also includes program code to test the machine learning model on a target domain, after training the machine learning model on the source domain. The program code further includes program code to train the machine learning model on the target domain by regularizing weights of the machine learning model such that shift-agnostic weights are subjected to a higher penalty than shift-biased weights.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor, in accordance with certain aspects of the present disclosure.

FIGS. 2A, 2B, and 2C are diagrams illustrating a neural network, in accordance with aspects of the present disclosure.

FIG. 2D is a diagram illustrating an exemplary deep convolutional network (DCN), in accordance with aspects of the present disclosure.

FIG. 3 is a block diagram illustrating an exemplary deep convolutional network (DCN), in accordance with aspects of the present disclosure.

FIG. 4 is a block diagram illustrating test-time adaptation with unlabeled online data, in accordance with various aspects of the present disclosure.

FIG. 5 is a block diagram illustrating shift-agnostic weight regularization (SWR), in accordance with various aspects of the present disclosure.

FIG. 6 is a block diagram illustrating source prototype generation before model deployment, in accordance with various aspects of the present disclosure.

FIG. 7 is a block diagram illustrating test-time adaptation after model deployment, in accordance with various aspects of the present disclosure.

FIG. 8 is a flow diagram illustrating a method for test-time adaptation via shift-agnostic weight regularization, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

A deep neural network (DNN) model may be trained using a given dataset (e.g., source domain). After initial training in the source domain, the model may be deployed and tested on a new environment (e.g., target domain). However, in most cases, there is a distribution gap between the source domain and the target domain. That is, the source and target domains are often different from one another. Thus, the model performance in the target domain is inferior to the performance in the source domain. Moreover, if the distribution gap is quite large, severe performance degradation may be observed.

Aspects of the present disclosure include a method that adapts a deployed model to the target domain using unlabeled online data in an unsupervised manner during test time. Conventionally, performance of a model may be reduced when all model parameters are updated by, and dependent on, an unsupervised objective function (e.g., without ground truth data). To address this issue, aspects of the present disclosure include a shift-agnostic (also referred to as style-agnostic) weight regularization where a higher penalty is given to update the network parameters insensitive to distribution shift. In these aspects, a lower penalty is given to update those weights sensitive to distribution shift. Consequently, in such aspects, all parameters may be updated without performance degradation.

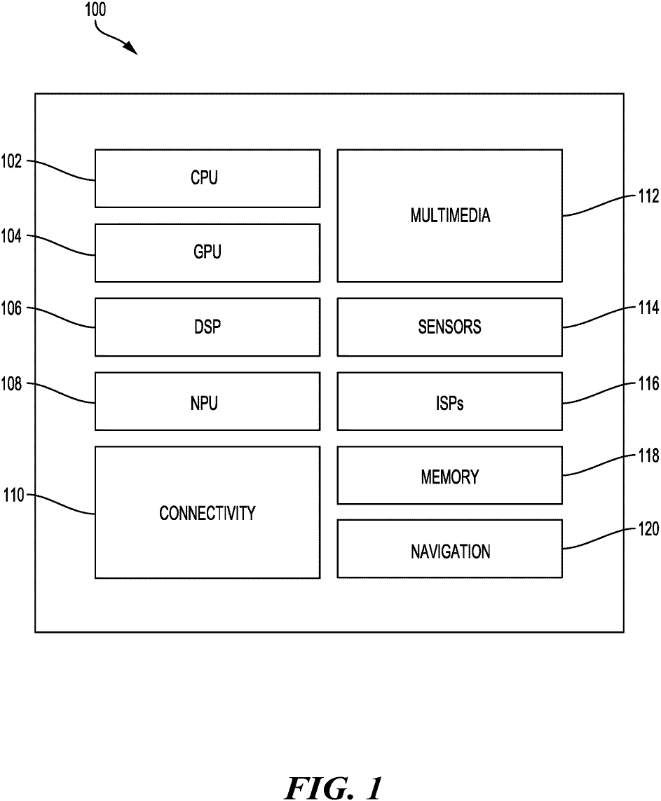

FIG. 1 illustrates an example implementation of a system-on-a-chip (SOC) 100, which may include a central processing unit (CPU) 102 or a multi-core CPU configured for improving test-time adaptation via shift-agnostic weight regularization. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to train a machine learning model on a source domain. The general-purpose processor 102 may also include code to test the machine learning model on a target domain, after training. The general-purpose processor 102 may also include code to training the machine learning model on the target domain by regularizing weights of the machine learning model such that shift-agnostic weights are subjected to a higher penalty than shift-biased weights.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

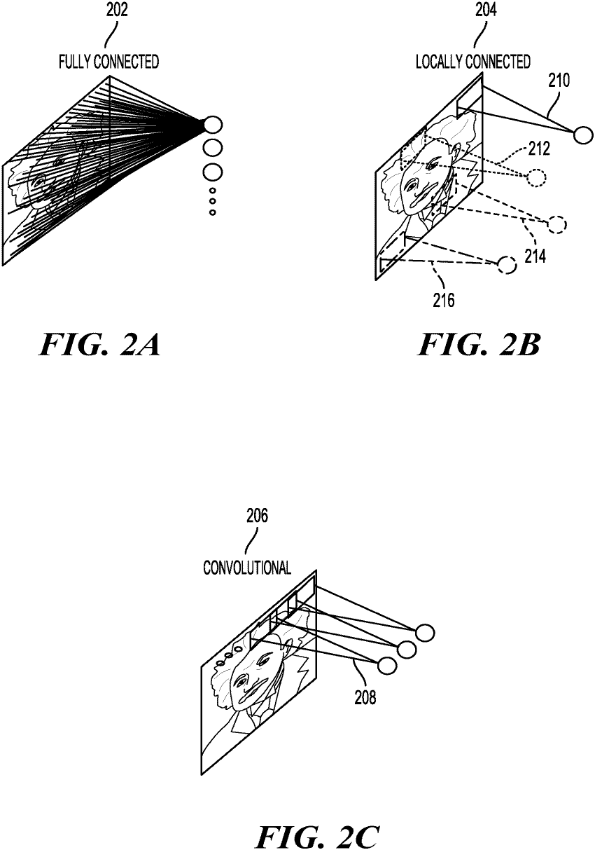

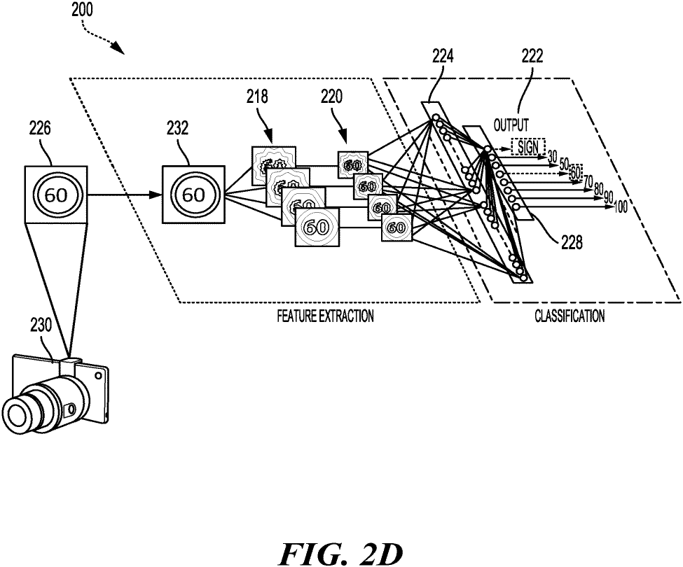

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

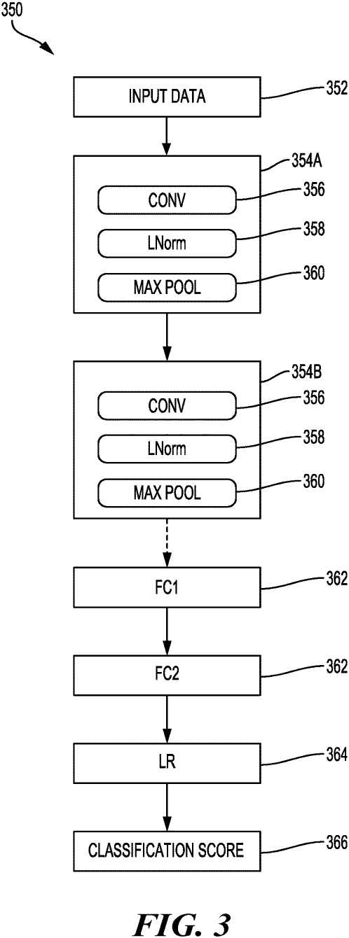

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

A deep neural network (DNN) model may be trained using a given dataset (e.g., source domain). After initial training in the source domain, the model may be deployed and tested on a new environment (e.g., target domain). The DNN makes predictions based on the data in the target domain. However, in most cases, there is a distribution gap between the source domain and the target domain. That is, the source and target domains are often different from one another. Thus, performance of the model in the target domain may be inferior to performance of the model in the source domain. Moreover, if the distribution gap is quite large, severe performance degradation may be observed. If the deployed model does not remain stationary during test time, but adapts to the new environment using clues about unlabeled target data, performance can be improved.

Aspects of the present disclosure include a method that adapts the deployed model to the target domain using unlabeled online data in an unsupervised manner during test time. Conventionally, when all model parameters are updated by, and dependent on, an unsupervised objective function (e.g., without ground truth data) performance degradation results. To address this issue, aspects of the present disclosure include a shift-agnostic (also referred to as style-agnostic) weight regularization where a higher penalty is given to update the network parameters insensitive to distribution shift. In these aspects, a lower penalty is given to update those weights sensitive to distribution shift. Consequently, all parameters may be updated without performance degradation.

The techniques of the present disclosure offer benefits of improved model performance, especially when a large distribution gap exists between the source and target domains. With previous methods, all model parameters are equally updated based on incorrect pseudo labels on target data (e.g., due to a large distribution gap), leading to a severe performance degradation.

Aspects of the present disclosure introduce a novel test-time adaptation strategy that adjusts a model pre-trained on a source domain using only unlabeled online data from a target domain to alleviate performance degradation due to a distribution shift between the source and target domains. Adapting all of the model parameters using the unlabeled online data may be detrimental due to erroneous signals from an unsupervised objective. To mitigate this problem, aspects of the present disclosure introduce a shift-agnostic weight regularization (SWR) that encourages largely updating the model parameters sensitive to distribution shift while slightly updating the model parameters insensitive to the shift, during test-time adaptation. This regularization enables the model to quickly adapt to the target domain without performance degradation by utilizing the benefit of a high learning rate. The shift-agnostic weight regularization enables the model to quickly adapt to a target domain, which is beneficial when updating the entire model parameters with a high learning rate. Entropy minimization with the proposed SWR shows superior performance and less dependency on a learning rate choice. In terms of distribution shift, the SWR classifies all of the model parameters into shift-agnostic and shift-biased parameters, updating the former less and the latter more.

In addition, an auxiliary task based on a nearest source prototypes aligns source and target features, which helps reduce the distribution shift and leads to further performance improvement. The auxiliary task based on a non-parametric nearest source prototype (NSP) classifier pulls the target representation closer to its nearest source prototype. With the NSP classifier, both the source and target representations can be well aligned, which significantly improves the performance of the main task.

The techniques of the present disclosure access source data to identify shift-agnostic and shift-biased parameters and to generate source prototypes before the model deployment. The techniques are applicable to any model regardless of architecture or pre-training procedure. If a given model is pre-trained on open datasets, or if the source data owner deploys the model, source data is accessible before model deployment. In this case, the method enhances the test-time adaptation capability by leveraging the source data without modifying the pre-trained model. The method does not change the pre-training method of a given model, so the method can benefit from any pre-trained models as a good starting point for test-time adaptation. Therefore, the method can complement other domain generalization approaches that mainly focus on the pre-training method in the source domain before model deployment.

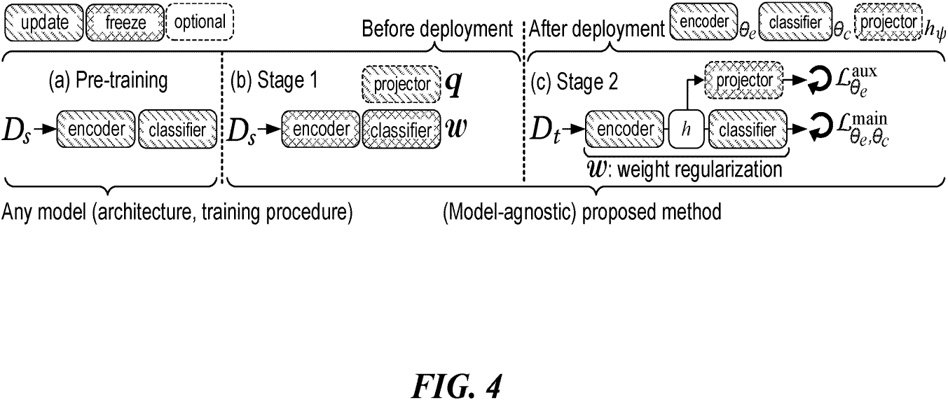

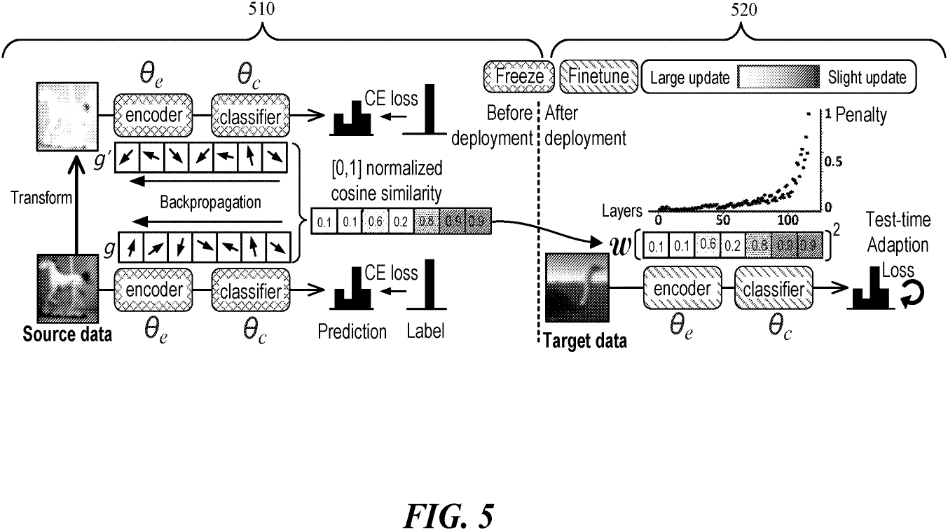

A more detailed explanation is now presented with respect to FIGS. 4 and 5. FIG. 4 is a block diagram illustrating test-time adaptation with unlabeled online data, in accordance with various aspects of the present disclosure. FIG. 5 is a block diagram illustrating shift-agnostic weight regularization (SWR), in accordance with various aspects of the present disclosure. The proposed method takes a pre-trained model in an off-the-shelf manner and generates a penalty vector w and source prototypes q while keeping the model frozen before model deployment. After model deployment, the method does not access labeled source data Dₛ other than unlabeled online target data Dₜ during test-time adaptation. As seen in FIG. 4, during stage 1, a penalty vector w is obtained, and the projection layer is trained while the original pre-trained model (encoder and classifier) is frozen. After model deployment, at stage 2, test-time adaptation is conducted using shift-agnostic regularization (with the penalty vector w) and nearest source prototypes (with a projection, or optionally without a projection). As seen in FIG. 5, before model deployment 510, the penalty vector w is obtained based on layer-wise cosine similarity between the gradients from the forward and backpropagation of the original image and its transformed image. After model deployment 520, the regularization based on the layer-wise penalty is applied to the test-time adaptation loss.

Assume that model parameters θ trained on a source domain consist of an encoder part θₑ and a classifier part θ_{c}. After being deployed to the target domain, the model infers the class probability distribution of the target sample and then optimizes a test-time adaptation loss

$${L}_{{θ}_{e} , {θ}_{c}}^{t a r g e t} .$$

The overall loss of the proposed method is defined as:

$${L}_{{θ}_{e} , {θ}_{c}}^{t a r g e t} = {L}_{{θ}_{e} , {θ}_{c}}^{m a i n} + {L}_{{θ}_{e}}^{a u x} + {λ}_{r} {\sum }_{l} {w}_{l} {\left‖{θ}_{l} - {θ}_{l}^{∗}\right‖}_{2}^{2} , \qquad \text{(1)}$$

where wₗ denotes the l-th element of the penalty vector w used to constrain the update of the model parameters, θₗ is the parameter vector of the l-th layer of the model. The l-th layer may denote a part divided into a number of units (e.g., torch.nn.Module units defined in the open source Pytorch framework). The gradient vector of each layer may be obtained using the function torch.nn.module.parameters()). The values θ* are the parameters from the previous update step, λᵣ, is the importance of the regularization term, and

$${L}_{{θ}_{e} , {θ}_{c}}^{m a i n}$$

and

$${L}_{{θ}_{e}}^{a u x}$$

denote the main and auxiliary losses, respectively. Optimizing the main task loss updates the entire model parameters θₑ and θ_{c}, whereas optimizing the auxiliary task loss updates only the encoder part θₑ.

The SWR imposes different penalties for each parameter update during test-time adaptation, depending on the sensitivity of each model parameter to the distribution shift. Assuming that the distribution shift is mainly caused by color and blur shifts, the distribution shift may be mimicked using transformation techniques such as color distortion and Gaussian blur.

To obtain the penalty vector w specified in Eq. (1), the method first forward-propagates two input images (e.g., the original (e.g., source data) and its transformed image) through the source pre-trained model and then back-propagates the task loss (e.g., cross entropy (CE)) using the source labels to produce two sets g and g′ of L gradient vectors, respectively, as seen in FIG. 5. Note that L is the total number of layers in the model. Then the l-th element wₗ of the penalty vector w is calculated by employing the average cosine similarity Sₗ between two gradient vectors, g and g′ from N source samples as:

$$\begin{matrix}{S}_{l} = \frac{1}{N} {\sum }_{i = 1}^{N} \frac{{g}_{l}^{i} ⋅ {{g}^{′}}_{l}^{i}}{\left‖{g}_{l}^{i}\right‖ \left‖{{g}^{′}}_{l}^{i}\right‖} ∈ ℝ , \\ w = {\left(v \left[{S}_{1} ; … ; {S}_{l} ; … ; {S}_{L}\right]\right)}^{2} ∈ {ℝ}^{L} ,\end{matrix} \qquad \text{(2)}$$

where v [·] denotes min-max normalization with the range of

$$\left[0 , 1\right] , {g}_{l}^{i}$$

and

$$g {′}_{l}^{i}$$

denote the l-th gradient vectors for the i-th source sample and its transformed sample, respectively. The parameter N denotes the total number of samples. Note that the penalty vector w is obtained from a frozen pre-trained source model before model deployment. Therefore, this process is independent of the source model’s pre-training method and does not require source data after model deployment, as shown in FIG. 4.

As shown in Eq. (1) and FIG. 5, during test-time adaptation, the method applies the layer-wise penalty value wₗ to the difference between previous and current model parameters for each layer, controlling the update of model parameters differently for each layer. Therefore, the model parameters belonging to the layers with high cosine similarity between the two gradient vectors are considered shift-agnostic, and are updated less by imposing high penalties. The SWR method takes advantage of high learning rates to adapt the model to the target domain quickly. As seen in the overall process shown in FIG. 5, the penalty vector w is obtained before model deployment and then used as layer-wise penalties to control the update of the model parameters at test-time adaptation after model deployment.

According to aspects of the present disclosure, an entropy objective is selected for a main task of a model. The main task of the model f_{θ} is defined as the task performed by the parameters θₑ and θ_{c}. The loss function for the main task during test time is built using the entropy of model predictions y̅ on test samples from the target distribution. Information maximization loss is adopted as an unsupervised learning objective for the main task. This loss consists of entropy minimization and mean entropy maximization as:

$${L}_{{θ}_{e} , {θ}_{c}}^{m a i n} = {λ}_{{m}_{1}} \frac{1}{N} {\sum }_{i} H \left(\tilde{{y}_{i}}\right) - {λ}_{{m}_{2}} H \left(\overline{y}\right) , \qquad \text{(3)}$$

where

$$H \left(p\right) = - {\sum }_{k = 1}^{C} {p}^{k} log {p}^{k} , \overline{y} = \frac{1}{N} {\sum }_{i} \tilde{{y}_{i}} , \text{and} {λ}_{{m}_{1}} \text{and} {λ}_{{m}_{2}}$$

indicate the importance of each term. The number of classes and the batch size are denoted by C and N, respectively. Entropy minimization makes individual predictions confident, and mean entropy maximization encourages average prediction within a batch to be close to the uniform distribution.

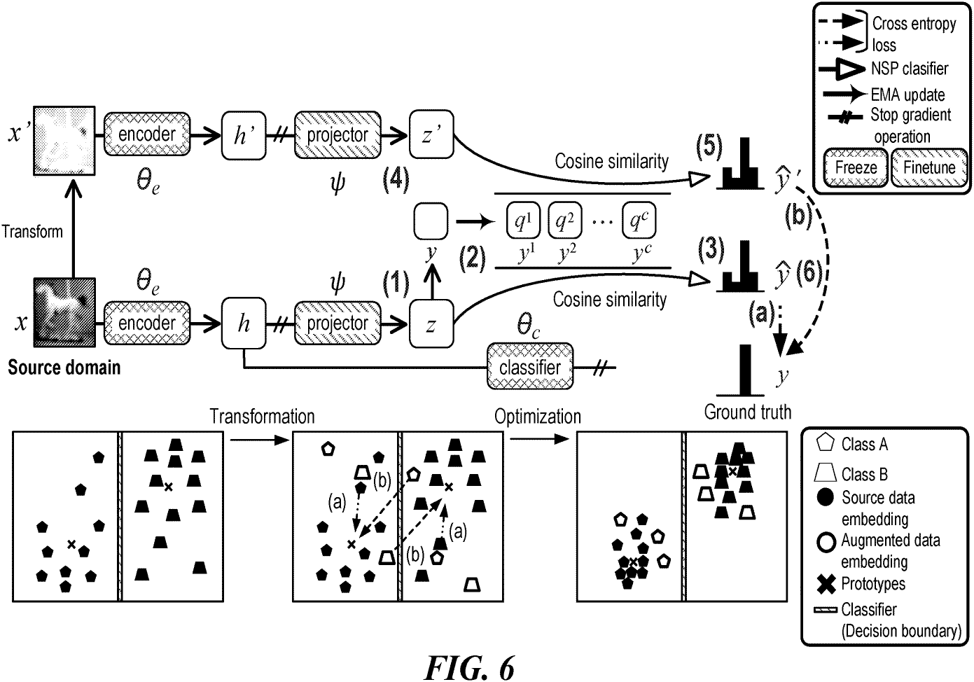

According to aspects of the present disclosure, an auxiliary task may be based on a nearest source prototype (NSP). Due to the distribution shift between the source and target domains, the target features may deviate from the source features at test time. To resolve this issue, an auxiliary task is based on the nearest source prototype (NSP) classifier, which pulls the target embeddings closer to their nearest source prototypes in the embedding space. Eventually, optimizing the auxiliary task improves performance because the auxiliary task directly supports the main task by aligning the source and target representations. How to generate source prototypes and define the NSP classifier based on the prototypes is now described with respect to FIG. 6.

FIG. 6 is a block diagram illustrating source prototype generation before model deployment, in accordance with various aspects of the present disclosure. A high level overview is initially presented and then a more detailed explanation will follow. First, steps (1) and (2) (described below) are repeated, until prototypes of all classes are generated. Then, the projector is trained and the source prototype is updated at the same time through an iterative process from steps (1) to (6) on the source data. Step (1) corresponds to inferring the representation h from the source sample x, and mapping the representation h to the projection z. Step (2) corresponds to updating the source prototypes for each class through an exponential moving average (EMA). Step (3) corresponds to measuring the cosine similarity of the projection z to the source prototypes for all classes and then generating a class probability distribution. Step (4) is the same as step (1) except for the transformed image x′. Step (5) is the same as step (3) except for the parameter z′. Step (6) corresponds to optimizing the embedding loss (as seen in equation (6)). This process encourages the projector to learn a mapping that pulls the projections belonging to the same class closer together and pushes source prototypes farther away from each other. The main task loss (a) and auxiliary task loss (b) pull the original source projection and its transformed source projection, respectively, such that they become closer to the nearest source prototype from the original projection.

Source prototypes are defined as the averages over source embeddings for each class. As shown in FIG. 6, the process freezes the model f_{θ} trained on the source data and attaches an additional projection layer h_{Ψ}, (also referred to as projector layer) behind the encoder

$${f}_{{θ}_{e}} .$$

The encoder

$${f}_{{θ}_{e}}$$

infers the representation h from the source sample x, and the projector h_{Ψ}, maps h to the projection z in another embedding space where the loss

$${L}_{ψ}^{e m b}$$

is applied as

$$z = {h}_{ψ} \left({f}_{{θ}_{e}} \left(x\right)\right) .$$

The projector h_{Ψ} provides interclass separation and intraclass cohesion. The source prototype

$${q}_{t}^{k}$$

for class k is updated through an exponential moving average (EMA) with the projection

$${z}_{t}^{k}$$

of the source sample (x,y^{k})_{k∈[1},_{C]} at time t during the optimization trajectory as:

$${q}_{t}^{k} = α ⋅ {q}_{t - 1}^{k} + \left(1 - α\right) ⋅ {z}_{t}^{k} , \qquad \text{(4)}$$

where α=0.99 (in one example implementation) θₑ and

$${q}_{0}^{k} = {z}_{0}^{k} .$$

The process defines the NSP classifier as a non-parametric classifier. The classifier measures the cosine similarity of a given target embedding to the source prototypes for all classes and then generates a class probability distribution y as:

$$\hat{y} = {\sum }_{k = 1}^{C} \left(\frac{exp \left(S \left(z , {q}^{k}\right) / τ\right)}{{\sum }_{j = 1}^{C} exp \left(S \left(z , {q}^{j}\right) / τ\right)}\right) {y}^{k} , \qquad \text{(5)}$$

where S(·,·)is a cosine similarity function, S(a,b) = ( a · b)/llall llbll, τ denotes a temperature that controls the sharpness of the distribution, and y^{k} is the one-hot ground truth label vector of the k-th class. In addition, based on recent self-supervised contrastive learning methods, the projector h_{Ψ}, learns a transformation-invariant mapping. The projection z′ of the transformed source sample is obtained by

$$z ′ = {h}_{ψ} \left({f}_{{θ}_{e}} \left(τ \left(x\right)\right)\right) ,$$

where J(·) denotes an image transform function. The embedding loss,

$${L}_{ψ}^{e m b} ,$$

consisting of two cross entropy loss terms, is applied to the embedding space to train the projector h_{Ψ}, as:

$${L}_{ψ}^{\text{emb}} = \frac{1}{N} {\sum }_{i = 1}^{N} \left(\text{CE} \left({y}_{i} , \hat{{y}_{i}}\right) + \text{CE} \left({y}_{i} , {{\hat{y}}^{′}}_{i}\right)\right) , \qquad \text{(6)}$$

where

$$\text{CE} \left(p , q\right) = - {\sum }_{k = 1}^{C} {p}^{k} log {q}^{k}$$

and yᵢis the ground truth label of the i-th source sample. Here, ŷ and ŷ’ denote the outputs of the NSP classifier for the projections z and z′ of the source sample and its transformed one, respectively. As shown in FIG. 6, optimizing the embedding loss encourages the projector h_{Ψ}, to learn a mapping that pulls the projections belonging to the same class closer together and pushes source prototypes farther away from each other. Note that this process is applied to a frozen pre-trained source model and completed before model deployment. Therefore, the process is model-agnostic and does not require source data during test time.

Auxiliary task loss at test time is now discussed. Once the source prototypes are generated and the projection layer is trained, the model may be deployed and both the main and auxiliary tasks may be jointly optimized on unlabeled online data. The auxiliary task loss

$${L}_{{θ}_{e}}^{a u x}$$

consists of two objective functions: the entropy objective

$${L}_{{θ}_{e}}^{a u x \_ e n t}$$

using the entropy of the NSP classifier’s prediction ŷ, and the self-supervised function

$${L}_{{θ}_{e}}^{a u x \_ s e l}$$

that encourages the model’s encoder

$${f}_{{θ}_{e}}$$

learn transformation-invariant mappings as:

$${L}_{{θ}_{e}}^{\text{aux}} = {L}_{{θ}_{e}}^{\text{aux\_ent}} + {\text{λ}}_{s} {L}_{{θ}_{e}}^{a u x \text{} \_ \text{} s e l} , \qquad \text{(7)}$$

where λₛdenotes the importance of the self-supervised loss term. Similarly to Eq. (3), the entropy objective is built by using the entropy of the prediction ŷ of the NSP classifier on the target sample as:

$${L}_{{θ}_{e}}^{a u x \text{} \_ \text{} e n t} = {\text{λ}}_{{a}_{1}} \frac{1}{N} {\sum }_{i = 1}^{N} H \left(\hat{{y}_{i}}\right) - {\text{λ}}_{{a}_{2}} H \left(\overline{y}\right) , \qquad \text{(8)}$$

where N is the batch size,

$${λ}_{{a}_{1}}$$

and

$${λ}_{{a}_{2}}$$

indicate the importance of each term,

$$H \left(p\right) = - {\sum }_{k = 1}^{C} {p}^{k} log {p}^{k} , \text{and} \hat{y} = \frac{1}{N} {\sum }_{i = 1}^{N} \hat{{y}_{i}} .$$

The self-supervised loss is applied to the prediction of the NSP classifier on the transformed target sample as:

$${L}_{{θ}_{e}}^{a u x \text{} \_ \text{} s e l} = - \frac{1}{N} {\sum }_{i = 1}^{N} {\sum }_{k = 1}^{C} {\hat{y}}_{i}^{k} log {{\hat{y}}^{′}}_{i}^{k} . \qquad \text{(9)}$$

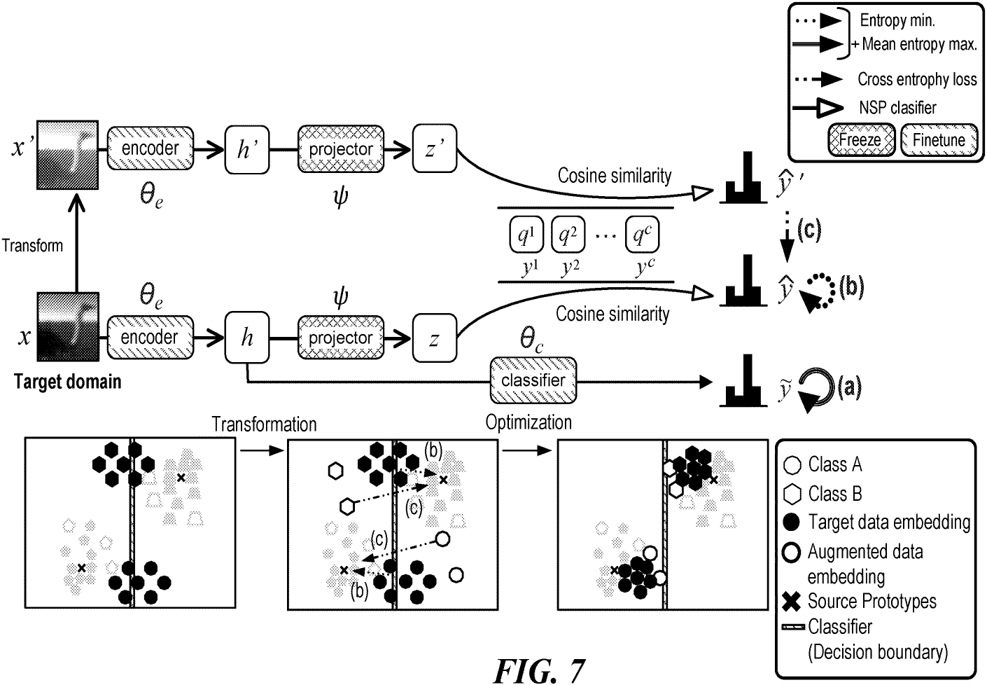

FIG. 6 denotes the source prototype generation phase before model deployment. This process is included in stage 1 in FIG. 4. The only projection layer is trained during this phase. FIG. 7 is a block diagram illustrating test-time adaptation after model deployment, in accordance with various aspects of the present disclosure. This process of FIG. 7 is included in stage 2 in FIG. 4. The encoder and classifier are trained during this phase. FIG. 7 shows a main task loss (a), an auxiliary task loss (b), and an auxiliary task loss (c). An entropy objective function and corresponding auxiliary task loss (b) pull the projection z of the original target sample to move closer to its nearest source prototype. The self-supervised objective and corresponding auxiliary task loss (c) encourage the projection z′of the transformed target sample to move closer to the same target as the projection z.

Aspects of the present disclosure introduce two novel approaches for model-agnostic test-time adaptation. The proposed shift-agnostic weight regularization (SWR) enables the model to reliably and quickly adapt to unlabeled online data from the target domain by controlling the update of the model parameters according to their sensitivity to the distribution shift. The SWR process controls the update of the model parameters depending on each parameter’s sensitivity to the distribution shift. If θ* in Eq. (1) is fixed as source model parameters without being updated with the model parameters from the previous step, it is difficult to sufficiently adapt the model to the target data. Constraining the model parameters to not move away significantly from the source model parameters is not the purpose of SWR (instead, NSP aligns source and target features based on the source prototypes). Updating θ* shows better performance than freezing θ*.

In addition, the proposed auxiliary task based on the nearest source prototype (NSP) classifier boosts the performance by aligning the source and target representations. The purpose of the NSP is twofold: (1) aligning target and source features by leveraging the source prototypes as reference points (FIG. 7, auxiliary task loss (b),

$${L}_{{θ}_{e}}^{a u x \_ e n t}$$

) and (2) learning input consistency (FIG. 7, auxiliary task loss (c),

$${L}_{{θ}_{e}}^{a u x \_ e n t}$$

The points

$${L}_{{θ}_{e}}^{a u x \_ s e t}$$

contribute more than the points

$${L}_{{θ}_{e}}^{a u x \_ s e l} .$$

Projector design includes attaching and training a projector behind the encoder to map the feature representation h to the projection z. The projector minimizes the misalignment between the source and target embeddings by enabling transformation-invariant mapping and bringing the projections belonging to the same class closer together in the new embedding space.

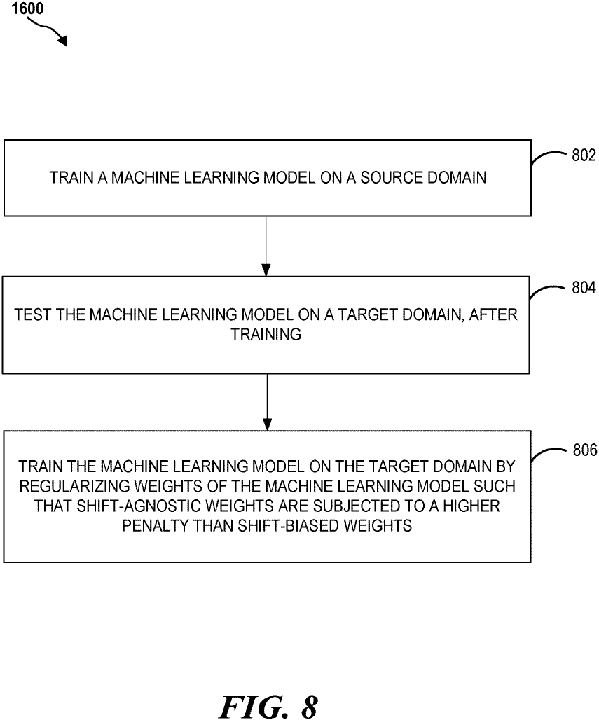

FIG. 8 is a flow diagram illustrating a method 800 for test-time adaptation via shift-agnostic weight regularization, in accordance with aspects of the present disclosure. As shown in FIG. 8, in some aspects, the method 800 may include training a machine learning model on a source domain (block 802). In some aspects, the method 800 may include testing the machine learning model on a target domain, after training the machine learning model on the source domain (block 804). In some aspects, the method 800 may also include training the machine learning model on the target domain by regularizing weights of the machine learning model such that shift-agnostic weights are subjected to a higher penalty than shift-biased weights (block 806).

### Example Aspects

Aspect 1: A processor-implemented method, comprising: training a machine learning model on a source domain; testing the machine learning model on a target domain, after training the machine learning model on the source domain; and training the machine learning model on the target domain by regularizing weights of the machine learning model such that shift-agnostic weights are subjected to a higher penalty than shift-biased weights.

Aspect 2: The processor-implemented method of Aspect 1, further comprising training the machine learning model based on a main task loss and an auxiliary task loss.

Aspect 3: The processor-implemented method of Aspect 1 or 2, in which the main task loss is based on an entropy derived from a predicted probability, by the machine learning model, on test samples from the target domain.

Aspect 4: The processor-implemented method of any of the preceding Aspects, in which the entropy comprises an entropy minimization loss.

Aspect 5: The processor-implemented method of any of the Aspects 1-3, in which the entropy comprises an entropy maximization loss.

Aspect 6: The processor-implemented method of any of the preceding Aspects, in which the auxiliary task loss moves target representations to a nearest class centroid of the source domain.

Aspect 7: The processor-implemented method of any of the Aspects 1-5, in which the auxiliary task loss is computed on a representation mapped into an embedding space.

Aspect 8: An apparatus, comprising: a memory; and at least one processor coupled to the memory, the at least one processor configured to: train a machine learning model on a source domain; test the machine learning model on a target domain, after training the machine learning model on the source domain; and train the machine learning model on the target domain by regularizing weights of the machine learning model such that shift-agnostic weights are subjected to a higher penalty than shift-biased weights.

Aspect 9: The apparatus of Aspect 8, in which the at least one processor is further configured to train the machine learning model based on a main task loss and an auxiliary task loss.

Aspect 10: The apparatus of Aspect 8 or 9, in which the main task loss is based on an entropy derived from a predicted probability, by the machine learning model, on test samples from the target domain.

Aspect 11: The apparatus of any of the Aspects 8-10, in which the entropy comprises an entropy minimization loss.

Aspect 12: The apparatus of any of the Aspects 8-10, in which the entropy comprises an entropy maximization loss.

Aspect 13: The apparatus of any of the Aspects 8-12, in which the auxiliary task loss moves target representations to a nearest class centroid of the source domain.

Aspect 14: The apparatus of any of the Aspects 8-12, in which the auxiliary task loss is computed on a representation mapped into an embedding space.

Aspect 15: An apparatus, comprising: means for training a machine learning model on a source domain; means for testing the machine learning model on a target domain, after training the machine learning model on the source domain; and means for training the machine learning model on the target domain by regularizing weights of the machine learning model such that shift-agnostic weights are subjected to a higher penalty than shift-biased weights.

Aspect 16: The apparatus of Aspect 15, further comprising means for training the machine learning model based on a main task loss and an auxiliary task loss.

Aspect 17: The apparatus of Aspect 15 or 16, in which the main task loss is based on an entropy derived from a predicted probability, by the machine learning model, on test samples from the target domain.

Aspect 18: The apparatus of any of the Aspects 15-17, in which the entropy comprises an entropy minimization loss.

Aspect 19: The apparatus of any of the Aspects 15-17, in which the entropy comprises an entropy maximization loss.

Aspect 20: The apparatus of any of the Aspects 15-19, in which the auxiliary task loss moves target representations to a nearest class centroid of the source domain.

Aspect 21: The apparatus of any of the Aspects 15-19, in which the auxiliary task loss is computed on a representation mapped into an embedding space.

Aspect 22: A non-transitory computer-readable medium having program code recorded thereon, the program code executed by a processor and comprising: program code to train a machine learning model on a source domain; program code to test the machine learning model on a target domain, after training the machine learning model on the source domain; and program code to train the machine learning model on the target domain by regularizing weights of the machine learning model such that shift-agnostic weights are subjected to a higher penalty than shift-biased weights.

Aspect 23: The non-transitory computer-readable medium of Aspect 22, in which the program code further comprises program code to train the machine learning model based on a main task loss and an auxiliary task loss.

Aspect 24: The non-transitory computer-readable medium of Aspect 22 or 23, in which the main task loss is based on an entropy derived from a predicted probability, by the machine learning model, on test samples from the target domain.

Aspect 25: The non-transitory computer-readable medium of any of the Aspects 22-24, in which the entropy comprises an entropy minimization loss.

Aspect 26: The non-transitory computer-readable medium of any of the Aspects 22-24, in which the entropy comprises an entropy maximization loss.

Aspect 27: The non-transitory computer-readable medium of any of the Aspects 22-26, in which the auxiliary task loss moves target representations to a nearest class centroid of the source domain.

Aspect 28: The non-transitory computer-readable medium of any of the Aspects 22-26, in which the auxiliary task loss is computed on a representation mapped into an embedding space.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
training a machine learning model on a source domain;
testing the machine learning model on a target domain, after training the machine learning model on the source domain; and
training the machine learning model on the target domain by regularizing weights of the machine learning model such that shift-agnostic weights are subjected to a higher penalty than shift-biased weights.

2. The processor-implemented method of claim 1, further comprising training the machine learning model based on a main task loss and an auxiliary task loss.

3. The processor-implemented method of claim 2, in which the main task loss is based on an entropy derived from a predicted probability, by the machine learning model, on test samples from the target domain.

4. The processor-implemented method of claim 3, in which the entropy comprises an entropy minimization loss.

5. The processor-implemented method of claim 3, in which the entropy comprises an entropy maximization loss.

6. The processor-implemented method of claim 2, in which the auxiliary task loss moves target representations to a nearest class centroid of the source domain.

7. The processor-implemented method of claim 6, in which the auxiliary task loss is computed on a representation mapped into an embedding space.

8. An apparatus, comprising:
a memory; and
at least one processor coupled to the memory, the at least one processor configured to:
train a machine learning model on a source domain;
test the machine learning model on a target domain, after training the machine learning model on the source domain; and
train the machine learning model on the target domain by regularizing weights of the machine learning model such that shift-agnostic weights are subjected to a higher penalty than shift-biased weights.

9. The apparatus of claim 8, in which the at least one processor is further configured to train the machine learning model based on a main task loss and an auxiliary task loss.

10. The apparatus of claim 9, in which the main task loss is based on an entropy derived from a predicted probability, by the machine learning model, on test samples from the target domain.

11. The apparatus of claim 10, in which the entropy comprises an entropy minimization loss.

12. The apparatus of claim 10, in which the entropy comprises an entropy maximization loss.

13. The apparatus of claim 9, in which the auxiliary task loss moves target representations to a nearest class centroid of the source domain.

14. The apparatus of claim 13, in which the auxiliary task loss is computed on a representation mapped into an embedding space.

15. An apparatus, comprising:
means for training a machine learning model on a source domain;
means for testing the machine learning model on a target domain, after training the machine learning model on the source domain; and
means for training the machine learning model on the target domain by regularizing weights of the machine learning model such that shift-agnostic weights are subjected to a higher penalty than shift-biased weights.

16. The apparatus of claim 15, further comprising means for training the machine learning model based on a main task loss and an auxiliary task loss.

17. The apparatus of claim 16, in which the main task loss is based on an entropy derived from a predicted probability, by the machine learning model, on test samples from the target domain.

18. The apparatus of claim 17, in which the entropy comprises an entropy minimization loss.

19. The apparatus of claim 17, in which the entropy comprises an entropy maximization loss.

20. The apparatus of claim 16, in which the auxiliary task loss moves target representations to a nearest class centroid of the source domain.

21. The apparatus of claim 20, in which the auxiliary task loss is computed on a representation mapped into an embedding space.

22. A non-transitory computer-readable medium having program code recorded thereon, the program code executed by a processor and comprising:
program code to train a machine learning model on a source domain;
program code to test the machine learning model on a target domain, after training the machine learning model on the source domain; and
program code to train the machine learning model on the target domain by regularizing weights of the machine learning model such that shift-agnostic weights are subjected to a higher penalty than shift-biased weights.

23. The non-transitory computer-readable medium of claim 22, in which the program code further comprises program code to train the machine learning model based on a main task loss and an auxiliary task loss.

24. The non-transitory computer-readable medium of claim 23, in which the main task loss is based on an entropy derived from a predicted probability, by the machine learning model, on test samples from the target domain.

25. The non-transitory computer-readable medium of claim 24, in which the entropy comprises an entropy minimization loss.

26. The non-transitory computer-readable medium of claim 24, in which the entropy comprises an entropy maximization loss.

27. The non-transitory computer-readable medium of claim 23, in which the auxiliary task loss moves target representations to a nearest class centroid of the source domain.

28. The non-transitory computer-readable medium of claim 27, in which the auxiliary task loss is computed on a representation mapped into an embedding space.
